(19) United States
(12) Patent Application Publication
(10) Pub. No.: US 2026/0330873 A1
(43) Pub. Date: Oct. 22, 2026

(54) MOTION ANALYSIS DEVICE, NON-TRANSITORY COMPUTER-READABLE STORAGE MEDIUM, AND MOTION ANALYSIS METHOD

(71) Applicant: Mitsubishi Electric Corporation, TOKYO (JP)

(72) Inventors: Masato SABANAI, Tokyo (JP); Katsuhiro KUSANO, Tokyo (JP); Shogo SHIMIZU, Tokyo (JP); Takayuki KODAIRA, Tokyo (JP)

(73) Assignee: Mitsubishi Electric Corporation, TOKYO (JP)

(21) Appl. No.: 19/529,334

(22) Filed: Feb. 4, 2026

Related U.S. Application Data
(63) Continuation of application No. PCT/JP2023/036957, filed on Oct. 12, 2023.

(51) Int. Cl. G06V 40/20; G06T 7/20; G06T 7/70; G06V 10/70

(52) U.S. Cl. CPC G06V 40/20; G06T 7/20; G06T 7/70; G06V 10/70; G06T 2207/20081; G06T 2207/30196

(57) ABSTRACT

A motion analysis device includes a joint position information acquisition unit to acquire positions of M joints (M≥2) of a worker included in an image; an operation identification unit to perform inference of an operation performed by the worker from the positions of the M joints by using a trained model, and identify the operation performed by the worker based on a result of the inference; and a utilization target selection unit to select N joints (1≤N<M) from the M joints to use positions of the N joints as utilization targets when confidence level of the inference is less than a predetermined threshold. When the confidence level of the inference is less than the predetermined threshold, the operation identification unit is configured to perform again inference of an operation performed by the worker based on the utilization targets by using one of the one or more trained models.

### CROSS REFERENCE TO RELATED APPLICATION

This application is a continuation application of International Application No. PCT/JP2023/036957 having an international filing date of Oct. 12, 2023, which is hereby expressly incorporated by reference into the present application.

### BACKGROUND OF THE INVENTION

### FIELD OF THE INVENTION

The present disclosure relates to a motion analysis device, a non-transitory computer-readable storage medium, and a motion analysis method.

### DESCRIPTION OF THE RELATED ART

At production sites in the manufacturing industry, operation time is measured to improve manual operation processes, etc. The operation time measurement can be performed with little burden by automatically identifying operations performed by workers using image recognition.

The posture analysis device described in Patent Document 1 identifies an operation from operation images by using a trained posture model, a region model, a background model, and a procedure model.

Patent Reference 1: Japanese Patent Application Publication No. 2020-201772

### SUMMARY OF THE INVENTION

However, in the conventional technique, the difference in joint position information, which indicates joint positions of the workers, can become significant depending on the habits of the workers who perform even the same operations, which makes the posture data of the workers inaccurate. For this reason, if a worker whose operation is to be identified is different from workers appearing in images used for training models, the conventional technique fails sometimes to identify the operation procedure accurately.

An object of one or more aspects of the present disclosure is to accurately identify an operation, even if a worker has a habit in performing the operation.

A motion analysis device according to a first aspect of this disclosure includes: a processor to execute a program; and a memory to store the program which, when executed by the processor, performs processes of, acquiring joint position information indicating positions of M joints (M being an integer greater than or equal to 2) of a worker included in an image; performing inference of an operation performed by the worker based on the positions of the M joints by using one of one or more trained models for inferring an operation performed by a person based on at least a joint position of the person, and identifying the operation performed by the worker based on a result of the inference; and selecting N joints (N being an integer satisfying 1≤N<M) from the M joints when confidence level of the inference is less than a predetermined threshold, and using positions of the N joints as utilization targets. When the confidence level of the inference is less than a predetermined threshold, the processor is configured to perform again inference of the operation performed by the worker based on the utilization targets by using one of the one or more trained models.

A motion analysis device according to a second aspect of this disclosure includes: a processor to execute a program; and a memory to store the program which, when executed by the processor, performs processes of, acquiring joint position information indicating positions of M joints (M being an integer greater than or equal to 2) of a worker included in an image; acquiring object position information indicating a position of an object included in the image; calculating a distance between the position of the object and each of the positions of the M joints; selecting N joints (N being an integer satisfying 1≤N<M) from joints whose distances are shorter than a predetermined threshold to use positions of the N joints as utilization targets; and performing inference of an operation performed by the worker based on the utilization targets by using a trained model for inferring an operation performed by a person based on joint positions of the person and a position of an object, and identifying the operation performed by the worker based on a result of the inference.

A motion analysis device according to a third aspect of this disclosure includes: a processor to execute a program; and

a memory to store the program which, when executed by the processor, performs processes of, acquiring joint position information indicating positions of M joints (M being an integer greater than or equal to 2) of a worker included in an image; acquiring object position information indicating a position of an object included in the image; calculating a distance between the position of the object and each of the positions of the M joints; using, as utilization targets, positions of N joints (N being an integer satisfying 1≤N<M) selected from joints whose distances are shorter than a predetermined threshold when the N joints is able to be selected from the joints whose distances are shorter than the predetermined threshold, and selecting the N joints from predetermined joints to use positions of the N joints as the utilization targets when the N joints is not able to be selected from the joints whose distances are shorter than the predetermined threshold; and performing inference of an operation performed by the worker based on the utilization targets by using one of one or more trained models for inferring an operation performed by a person based on at least a joint position of the person, and identifying the operation performed by the worker based on a result of the inference.

A non-transitory computer-readable storage medium according to the first aspect of the present disclosure storing a program that causes a computer to execute processing including: acquiring joint position information indicating positions of M joints (M being an integer greater than or equal to 2) of a worker included in an image; preforming inference of an operation performed by the worker based on the positions of the M joints by using one of one or more trained models for inferring an operation performed by a person based on at least a joint position of the person, and identifying the operation performed by the worker based on a result of the inference; and selecting N joints (N being an integer satisfying 1≤N<M) from the M joints to use positions of the N joints as utilization targets when confidence level of the inference is less than a predetermined threshold. When the confidence level of the inference is less than the predetermined threshold, the computer is configured to perform again inference of the operation performed by the worker based on the utilization targets by using one of the one or more trained models.

A non-transitory computer-readable storage medium according to the second aspect of the present disclosure storing a program that causes a computer to execute processing including: acquiring joint position information indicating positions of M joints (M being an integer greater than or equal to 2) of a worker included in an image; acquiring object position information indicating a position of an object included in the image; calculating a distance between the position of the object and each of the positions of the M joints; selecting N joints (N being an integer satisfying 1≤N<M) from joints whose distances are shorter than a predetermined threshold to use positions of the N joints as utilization targets; and performing inference of an operation performed by the worker based on the utilization targets by using a trained model for inferring an operation performed by a person based on a joint position of the person and a position of an object, and identifying the operation performed by the worker based on a result of the inference.

A non-transitory computer-readable storage medium according to the third aspect of the present disclosure storing a program that causes a computer to execute processing including: acquiring joint position information indicating positions of M joints (M being an integer greater than or equal to 2) of a worker included in an image; acquiring object position information indicating a position of an object included in the image; calculating a distance between the position of the object and each of the positions of the M joints; using, as utilization targets, positions of N joints (N being an integer satisfying 1≤N<M) selected from joints whose distances are shorter than a predetermined threshold when the N joints is able to be selected from the joints whose distances are shorter than the predetermined threshold, and selecting the N joints from predetermined joints to use positions of the N joints as the utilization targets when the N joints is not able to be selected from the joints whose distances are shorter than the predetermined threshold; and performing inference of an operation performed by the worker based on the utilization targets by using one of one or more trained models for inferring an operation performed by a person based on at least a joint position of the person, and identifying the operation performed by the worker based on a result of the inference.

A motion analysis method according to the first aspect of the present disclosure includes: acquiring joint position information indicating positions of M joints (M being an integer greater than or equal to 2) of a worker included in an image; performing inference of an operation performed by the worker based on the positions of the M joints by using a trained model for inferring an operation performed by a person based on at least a joint position of the person, and identifying the operation performed by the worker based on a result of the inference; selecting N joints (N being an integer satisfying 1≤N<M) from the M joints to use positions of the N joints as utilization targets when confidence level of the inference is less than a predetermined threshold; and performing inference of the operation performed by the worker again based on the utilization targets by using one of the one or more trained models when the confidence level of the inference is less than the predetermined threshold.

A motion analysis method according to the second aspect of the present disclosure includes: acquiring joint position information indicating positions of M joints (M being an integer greater than or equal to 2) of a worker included in an image; acquiring object position information indicating a position of an object included in the image; calculating a distance between the position of the object and a position of each of the M joints; selecting N joints (N being an integer satisfying 1≤N<M) from joints whose distances are shorter than a predetermined threshold to use positions of the N joints as utilization targets; and performing inference of an operation performed by the worker based on the utilization targets by using a trained model for inferring an operation performed by a person based on a joint position of the person and a position of an object, and identifying the operation performed by the worker based on a result of the inference.

A motion analysis method according to the third aspect of the present disclosure includes: acquiring joint position information indicating positions of M joints (M being an integer greater than or equal to 2) of a worker included in an image; acquiring object position information indicating a position of an object included in the image; calculating a distance between the position of the object and a position of each of the M joints; using, as utilization targets, positions of N joints (N being an integer satisfying 1≤N<M) selected from joints whose distances are shorter than a predetermined threshold when the N joints is able to be selected from the joints whose distances are shorter than the predetermined threshold; selecting the N joints from predetermined joints to use positions of the N joints as the utilization targets when the N joints is not able to be selected from the joints whose distances are shorter than the predetermined threshold; and performing inference of an operation performed by the worker based on the utilization targets by using one of one or more trained models for inferring an operation performed by a person based on at least a joint position of the person, and identifying the operation performed by the worker based on a result of the inference.

According to one or more embodiments of the present disclosure, an operation can be accurately identified, even if a worker has a habit in performing the operation.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram schematically illustrating a configuration of a motion analysis device according to a first embodiment;

FIG. 2 is a schematic diagram illustrating a first example of joint position information;

FIG. 3 is a schematic diagram illustrating a second example of the joint position information;

FIG. 4A and FIG. 4B are schematic diagrams illustrating a first example of a motion of a worker during training of an operation identification model;

FIG. 5A and FIG. 5B are schematic diagrams illustrating a second example of a motion of a worker during training of an operation identification model;

FIG. 6 is a block diagram schematically illustrating a configuration of a PC;

FIG. 7 is a flowchart illustrating the operation of the motion analysis device according to the first embodiment;

FIG. 8 is a block diagram schematically illustrating a configuration of a motion analysis device according to a second embodiment;

FIG. 9 is a schematic diagram illustrating an example of a motion of a worker during inference;

FIG. 10 is a flowchart illustrating the operation of the motion analysis device according to the second embodiment;

FIG. 11 is a block diagram schematically illustrating a configuration of a motion analysis device according to a third embodiment;

FIG. 12 is a schematic diagram for explaining distances between an object and joint positions;

FIG. 13 is a flowchart illustrating the operation of the motion analysis device according to the third embodiment;

FIG. 14 is a block diagram schematically illustrating a configuration of a motion analysis device according to a fourth embodiment; and

FIG. 15 is a flowchart illustrating the operation of the motion analysis device according to the fourth embodiment.

### DETAILED DESCRIPTION OF THE INVENTION

### FIRST EMBODIMENT

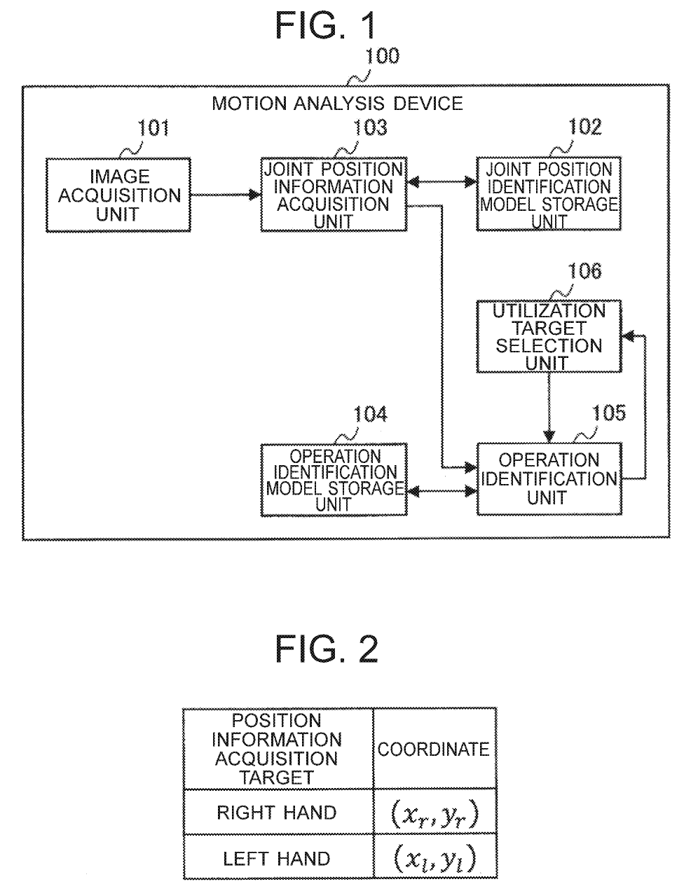

FIG. 1 is a block diagram schematically illustrating a configuration of a motion analysis device 100 according to a first embodiment.

The motion analysis device 100 includes an image acquisition unit 101, a joint position identification model storage unit 102, a joint position information acquisition unit 103, an operation identification model storage unit 104, an operation identification unit 105, and a utilization target selection unit 106.

The image acquisition unit 101 acquires an image. For example, the image acquisition unit 101 may receive image data indicating the image from a network via a communication unit, which is not illustrated, or may read image data indicating the image from a storage unit, which is not illustrated. The acquired image is provided to the joint position information acquisition unit 103.

The joint position identification model storage unit 102 stores a joint position identification model that is a trained model for identifying a joint position of a worker from an image. The joint position identification model is a model for inferring, based on an image, a joint position of a worker included in the image.

The joint position information acquisition unit 103 acquires joint position information indicating the positions of M joints (M being an integer of 2 or more) of a worker included in the image from the image acquisition unit 101.

For example, the joint position information acquisition unit 103 inputs the image from the image acquisition unit 101 to the joint position identification model stored in the joint position identification model storage unit 102, thereby identifying joint positions that are an inference result based on the joint position identification model. Here, it is assumed that the joints whose positions are to be identified are determined in advance depending on an operation being performed by a worker, etc. Further, it is assumed that the inference result based on the joint position identification model includes information for identifying joints, such as the names of the joints, together with the positions of the joints.

Then, the joint position information acquisition unit 103 generates joint position information indicating the identified joint positions, thereby acquiring the joint position information.

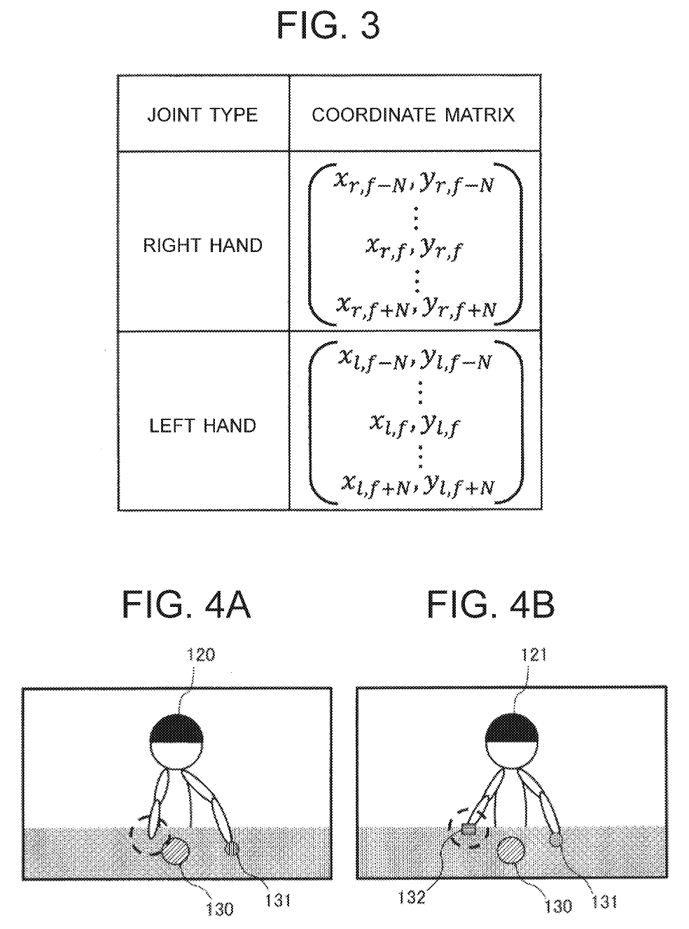

Here, the joint position information may be, for example, information indicating coordinates of the joints (here, the right wrist and the left wrist) at a frame time f at which the operation is identified, as illustrated in FIG. 2; or it may be, for example, matrices of coordinates identified from images of frames included in a predetermined time N before and after the frame time f at which the operation is identified, as illustrated in FIG. 3.

The operation identification model storage unit 104 stores one or more operation identification models that are one or more trained models for inferring an operation being performed by a person based on at least a joint position of the person.

Here, as an example, a description will be given assuming that one operation identification model is stored. The operation identification model storage unit 104 may store an operation identification model for identifying an operation of a worker based on the positions of M joints (M being an integer greater than or equal to 2), and an operation identification model used for identifying an operation of a worker based on the positions of N joints (N being an integer satisfying 1≤N<M) selected from the M joints.

The operation identification unit 105 performs inference of the operation being performed by the worker based on the positions of the M joints, by using one of the one or more trained models stored in the operation identification model storage unit 104, and then identifies the operation being performed by the worker based on the result of the inference.

For example, upon acquiring the joint position information from the joint position information acquisition unit 103, the operation identification unit 105 first inputs the positions of multiple joints indicated by the joint position information into the operation identification model stored in the operation identification model storage unit 104, thereby acquiring, as the inference result, the operation and the confidence level of the inference.

When the confidence level that is the inference result is equal to or greater than a predetermined threshold, the operation identification unit 105 identifies the operation that is the inference result as the operation of the worker.

On the other hand, when the confidence level is less than the predetermined threshold, the operation identification unit 105 provides a request to the utilization target selection unit 106 to select a utilization target, by turning on a utilization target flag, for example. In this case, the operation identification unit 105 provides the joint position information from the joint position information acquisition unit 103 to the utilization target selection section 106.

Next, when the operation identification unit 105 receives notification of the selected utilization target from the utilization target selection section 106, the operation identification unit 105 then inputs the utilization target into the operation identification model stored in the operation identification model storage unit 104, thereby acquiring, as the inference result, the operation and the confidence level of the inference, as described below. Here, the operation identification unit 105 receives notification of multiple utilization targets from the utilization target selection unit 106, the operation identification unit 105 then inputs each of the multiple utilization targets into the operation identification model, thereby acquiring the operation and the confidence level of the inference, as the inference result for each of the multiple utilization targets.

In other words, when the confidence level of the inference is less than the predetermined threshold, the operation identification unit 105 performs inference of the operation being performed by the worker again based on the utilization targets, using one of the one or more trained models stored in the operation identification model storage unit 104.

On the other hand, when the confidence level that is the inference result for the utilization targets is equal to or greater than the predetermined threshold, the operation identification unit 105 identifies the operation that is the inference result for the utilization targets as the operation of the worker. Here, multiple operations may be identified.

When the confidence level that is the inference result for the utilization targets is less than the predetermined threshold, the operation identification unit 105 may identify one operation selected from operations that are the inference results for the utilization targets, as the operation of the worker; or the operation identification unit 105 may identify a predetermined number of operations in descending order of the confidence level.

Alternatively, when the confidence level that is the inference result for the utilization target is less than the predetermined threshold, the operation identification unit 105 does not necessarily need to identify the operation. In this case, the operation identification unit 105 may identify the operation being performed by the worker as an unknown operation.

In response to the request from the operation identification unit 105, the utilization target selection unit 106 selects a utilization target that is to be used as input to the trained model, from the joint position information acquired by the joint position information acquisition unit 103. For example, when the confidence level of the inference by the operation identification unit 105 is less than the predetermined threshold, the utilization target selection unit 106 selects N joints from the M joints to use the positions of the N joints as utilization targets. Here, the utilization target selection unit 106 selects predetermined joints out of the multiple joints indicated by the joint position information, and selects the selected joints and their positions as utilization targets.

Then, the utilization target selection unit 106 notifies the operation identification unit 105 of the selected utilization targets.

The processing performed by the operation identification unit 105 and the utilization target selecting unit 106 will be described below using concrete examples.

Here, it is assumed that the operation identification model is trained using wrists of workers and their positions as input data.

During training of the operation identification model, as illustrated in FIG. 4A, it is assumed that a worker 120 is assembling a product 130 by performing an operation of handling a first component 131 with the left hand, while holding nothing in the right hand.

In such a case, during inference using the operation identification model, in order to assemble the product 130, if a worker 121 performs an operation of handling a second component 132 with the right hand while performing the operation of handling the first component 131 with the left hand, as illustrated in FIG. 4B, the position of the right wrist joint of the worker 120 during training significantly differs from the position of the right wrist joint of the worker 121 during inference. Thus, even if the position of the right wrist joint and the position of the left wrist joint are input into the operation identification model, the confidence level of the inference using the operation identification model is lowered.

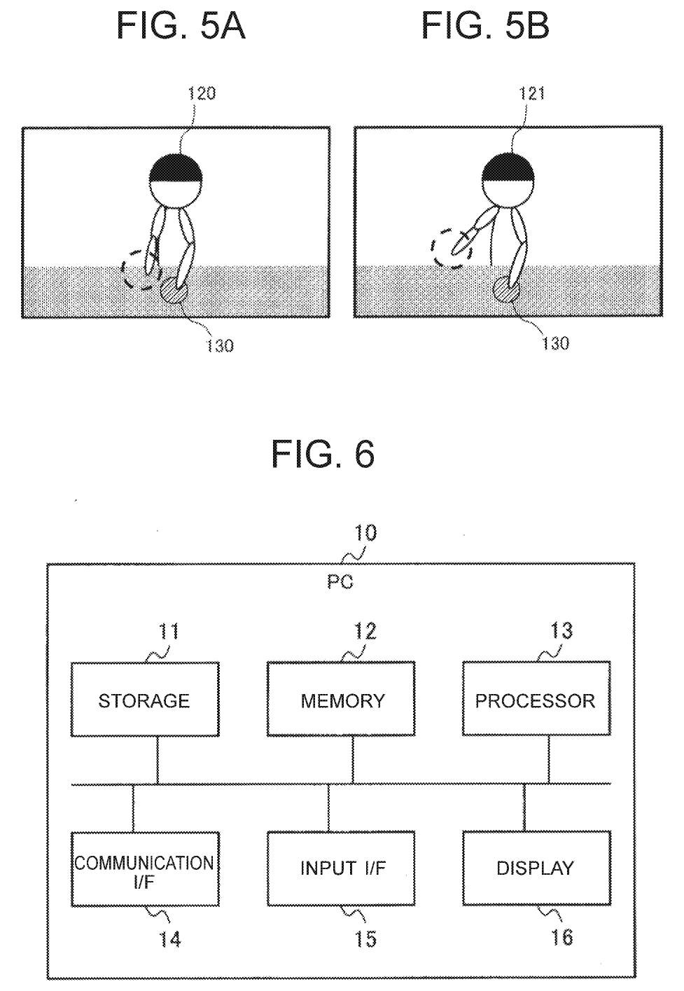

Further, as illustrated in FIG. 5A, during training of the operation identification model, it is assumed that the worker 120 is assembling the product 130 by performing the operation of handling the product 130 with the left hand while placing the right hand, which is not holding anything, near the left hand.

In such a case, during inference using the operation identification model, if the worker 121 performs the operation of handling the product 130 with the left hand while placing the right hand at a position distant from the left hand, as illustrated in FIG. 5B, the position of the right wrist joint of the worker 120 during training significantly differs from the position of the right wrist joint of the worker 121 during inference. Thus, even if the position of the right wrist joint and the position of the left wrist joint are input to the operation identification model, the confidence level of the inference using the operation identification model is lowered.

To cope with this, in the case illustrated in FIG. 4B, the utilization target selection unit 106 selects multiple joints, i.e., the right wrist joint and the left wrist joint, as utilization targets, and the operation identification unit 105 inputs only the position of the right wrist joint into the operation identification model, and then inputs only the position of the left wrist joint into the operation identification model. Therefore, each of the operation of handling the first component 131 and the operation of handling the second component 132 can be inferred with high confidence level.

Further, in the case illustrated in FIG. 5B, the utilization target selection unit 106 selects the positions of multiple joints, i.e., the right wrist joint and the left wrist joint, as utilization targets, and the operation identification unit 105 inputs only the position of the right wrist joint into the operation identification model, and then inputs only the position of the left wrist joint into the operation identification model. Therefore, the operation of handling the first component 131 can be inferred with high confidence.

This is because operation inference can be performed using only the positions of joints that significantly influence the inference of each operation.

The motion analysis device 100 described above can be implemented by a computer such as a PC 10 illustrated in FIG. 6, for example.

The PC 10 includes: storage 11 such as an HDD (Hard Disk Drive) and an SSD (Solid State Drive); a memory 12; a processor 13 such as a CPU (Central Processing Unit); a communication I/F (InterFace) 14 such as an NIC (Network Interface Card); an input I/F 15 such as a keyboard and a mouse; and a display 16.

For example, the joint position identification model storage unit 102 and the operation identification model storage unit 104 can be implemented by the storage 11 or the memory 12.

The image acquisition unit 101, the joint position information acquisition unit 103, the operation identification unit 105 and the utilization target selection unit 106 can be implemented by the processor 13 executing a program stored in the storage 11.

The program mentioned above may be downloaded to the storage 11 from a recording medium not illustrated in the drawings via a reader/writer not illustrated in the drawings, or from a network via the communication I/F 14. Alternatively, the program may be directly loaded onto the memory 12 from the recording medium via the reader/writer, or from a network via the communication I/F 14, and then may be executed by the processor 13.

In other words, the program may be provided by a program product such as a recording medium.

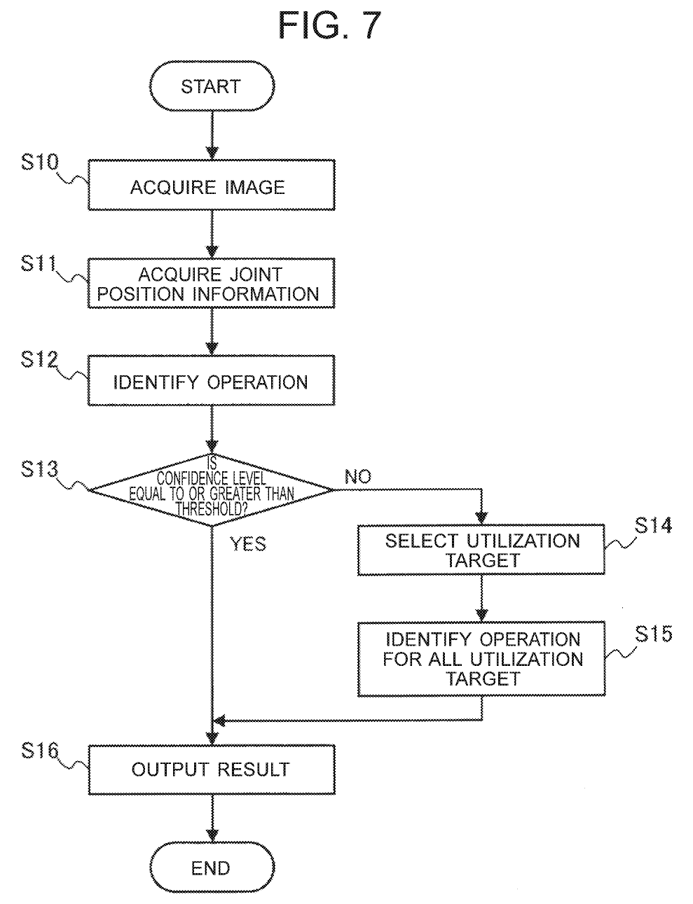

FIG. 7 is a flowchart illustrating the operation of the motion analysis device 100 according to the first embodiment.

First, the image acquisition unit 101 acquires an image (S10). The acquired image is provided to the joint position information acquisition unit 103.

The joint position information acquisition unit 103 acquires joint position information indicating the positions of multiple joints of the worker included in the image from the image acquisition unit 101 (S11).

For example, in the specific example illustrated in FIGS. 4A and 4B or 5A and 5B, the joint position information acquisition unit 103 acquires the joint position information indicating the position of the right wrist joint and the position of the left wrist joint. It is assumed that the joint position information also includes information for identifying joints in association with their positions.

Upon acquiring the joint position information from the joint position information acquisition unit 103, the operation identification unit 105 first inputs the joint positions indicated by the joint position information into the operation identification model stored in the operation identification model storage unit 104, thereby acquiring, as the inference result, the operation and the confidence level of the inference (S12). Here, since the joint position information indicates the positions of multiple joints, the operation is inferred by inputting the positions of multiple joints into the operation identification model.

The operation identification unit 105 determines whether the confidence level that is the inference result of the inference in step S12 is equal to or greater than a predetermined threshold (S13). If the confidence level is less than the predetermined threshold (NO in S13), the process proceeds to step S14. If the confidence level is equal to or greater than the predetermined threshold (YES in S13), the process proceeds to step S16.

In step S14, in response to a request from the operation identification unit 105, the utilization target selection unit 106 selects a utilization target that is a target to be used as input to the trained model, from the joint position information acquired by the joint position information acquisition unit 103. Here, the utilization target selection unit 106 selects, out of the multiple joints indicated by the joint position information, predetermined joints that are parts of the multiple joints, and selects the selected joints and their positions as utilization targets.

Then, upon receiving the selected multiple utilization targets from the utilization target selection unit 106, the operation identification unit 105 inputs each of the multiple utilization targets into the operation identification model stored in the operation identification model storage unit 104, thereby acquiring, as the inference result, the operation and the confidence level of the inference (S15). Then, the process proceeds to step S16.

In step S16, when the confidence level that is the inference result for the utilization target is equal to or greater than a predetermined threshold, the operation identification unit 105 identifies the operation that is the inference result for the utilization target, as the operation being performed by the worker. Here, multiple operations may be identified.

In step S15, when the confidence level that is the inference result for the utilization target is less than the predetermined threshold, the operation identification unit 105 may identify one operation selected, out of the operations that are the inference result for the utilization targets, as the operation of the worker, or may identify a predetermined number of operations in descending order of the confidence level.

Further, when the confidence level that is the inference result for the utilization target is less than the predetermined threshold, the operation identification unit 105 does not necessarily need to identify the operation. In this case, the operation identification unit 105 may treat the identified operation or the failure to identify the operation as a result of the motion, or may identify the operation of the worker as an unknown operation.

As described above, according to the first embodiment, even if a worker performs an operation during inference with a motion that is not a motion of a worker during training, the operation can be accurately identified by performing inference using only part of joints that significantly influences operation inference.

### SECOND EMBODIMENT

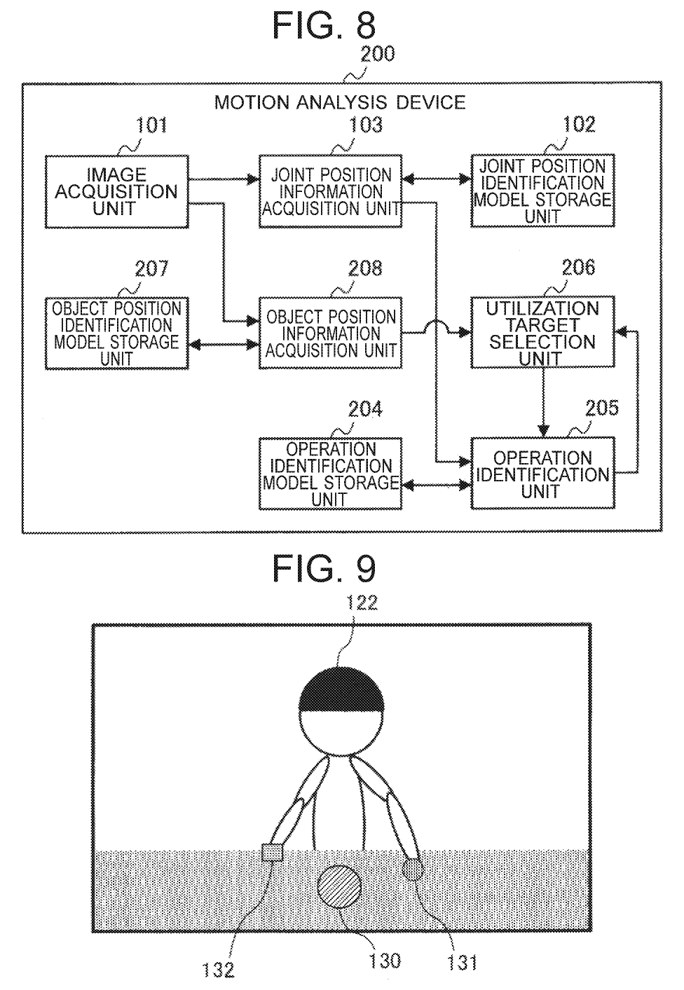

FIG. 8 is a block diagram schematically illustrating a motion analysis device 200 according to a second embodiment.

The motion analysis device 200 includes an image acquisition unit 101, a joint position identification model storage unit 102, a joint position information acquisition unit 103, an operation identification model storage unit 204, an operation identification unit 205, a utilization target selection unit 206, an object position identification model storage unit 207, and an object position information acquisition unit 208.

The image acquisition unit 101, the joint position identification model storage unit 102, and the joint position information acquisition unit 103 of the motion analysis device 200 according to the second embodiment are similar to the image acquisition unit 101, the joint position identification model storage unit 102, and the joint position information acquisition unit 103 of the motion analysis device 100 according to the first embodiment.

However, the image acquisition unit 101 according to the second embodiment also provides an acquired image to the object position information acquisition unit 208.

The object position identification model storage unit 207 stores an object position identification model that is a trained model for identifying an object position as the position of an object from an image. The object position identification model is a model that infers, from an image, the position of an object included in the image.

The object position information acquisition unit 208 acquires object position information that indicates the position of an object included in an image from the image acquisition unit 101.

For example, the object position information acquisition unit 208 inputs the image from the image acquisition unit 101 into the object position identification model stored in the object position identification model storage unit 207, thereby identifying the object position that is an inference result by the object position identification model. It is assumed that the object whose position is to be identified here is determined in advance according to an operation being performed by a worker, etc. It is also assumed that the inference result by the object position identification model includes information for identifying the object and the position of the object.

Then, the object position information acquisition unit 208 generates object position information indicating the identified object position, thereby acquiring the object position information.

Here, the object position information may be information indicating the coordinates of the object at a frame time f at which the object is identified, as in the explanation of FIG. 2, for example; the object position information may be a matrix of coordinates identified based on images of frames within a predetermined time N before and after the frame time f at which the object is identified, as in the explanation of FIG. 3, for example.

The operation identification model storage unit 204 stores multiple operation identification models for identifying operations of the workers by inputting joint positions of workers.

In the second embodiment, the operation identification model storage unit 204 stores a multiple-joint operation identification model for inferring operations of workers from the positions of multiple joints, and a combination operation identification model for inferring operations of workers for each predetermined combination selected from multiple objects and multiple joints.

Upon acquiring the joint position information from the joint position information acquisition unit 103, the operation identification unit 205 first inputs the positions of multiple joints indicated by the joint position information into the multiple-joint operation identification model stored in the operation identification model storage unit 204, thereby acquiring, as the inference result, the operation and the confidence level of the inference.

Then, when the confidence level of the inference result is equal to or greater than a predetermined threshold, the operation identification unit 205 identifies the operation that is the inference result as the operation of the worker.

On the other hand, when the confidence level is less than the predetermined threshold, the operation identification unit 205 provides a request to select a utilization target to the utilization target selection unit 206, by turning on a utilization target flag, for example. In this case, the operation identification unit 205 provides the joint position information from the joint position information acquiring unit 103, to the utilization target selection unit 206.

Next, upon receiving multiple utilization targets selected from the utilization target selection unit 206, the operation identification unit 205 inputs each of the multiple utilization targets into the corresponding combination operation identification model stored in the operation identification model storage unit 204, thereby acquiring, as the inference result, the operation and the confidence level of the inference.

Then, when the confidence level that is the inference result for the utilization object is equal to or greater than a predetermined threshold, the operation identification unit 205 identifies the operation that is the inference result for the utilization object as the operation of the worker. Here, multiple operations may be identified.

When the confidence level that is the inference result for the utilization object is less than the predetermined threshold, the operation identification unit 205 may identify one operation selected from the operations that are the inference result for the utilization object, as being the operation of the worker, or the operation identification unit 205 may identify a predetermined number of operations in descending order of the confidence level.

Alternatively, when the confidence level that is the inference result for the utilization object is less than the predetermined threshold, the operation identification unit 205 does not need necessarily to identify an operation. In this case, the operation identification unit 205 may identify the operation of the worker as an unknown operation.

In response to the request from the operation identification unit 205, the utilization target selection unit 206 selects a utilization target to be used as input to the trained model, from the joint position information acquired by the joint position information acquisition unit 103 and the object position information acquired by the object position information acquisition unit 208. For example, the utilization target selection unit 206 selects N joints from joints associated in advance with the object indicated by the object position information, to use the positions of the N joints and the position of the object as utilization targets. Here, the utilization target selection unit 206 may select a predetermined combination from the multiple joints indicated by the joint position information and the multiple objects indicated by the object position information, to select the selected combination and the positions of the joints and the object included in the combination, as the utilization targets.

Then, the utilization target selection unit 206 notifies the operation identification unit 205 of the selected utilization targets.

The processing in the operation identification unit 205 and the utilization target selecting unit 206 will be described below using a specific example.

Here, the following explanation will be provided in the assumption that the multiple-joint operation identification model is trained using the positions of wrist joints of workers as input data, and that the combination operation identification model is trained using combinations of the positions of the wrist joints of the workers and the positions of components as the objects as input data.

In this explanation, during training of the multi-joint operation identification model, it is also assumed that the worker 120 is assembling the product 130 by performing the operation of handling the first component 131 with the left hand while holding nothing in the right hand, as illustrated in FIG. 4A.

In such a case, during inference using the operation identification model, if the worker 122 is assembling the product 130 by performing the operation of handling the first component 131 with the left hand while performing an operation of handling the second component 132 with the right hand, as illustrated in FIG. 9, the position of the right wrist joint of the worker 120 during training significantly differs from the position of the right wrist joint of the worker 122 during inference. Thus, even if the position of the right wrist joint and the position of the left wrist joint are input to the operation identification model, the confidence level of the inference using the operation identification model is lowered.

Therefore, in the second embodiment, the utilization target selection unit 206 selects, as utilization targets, a combination of the position of the left wrist joint and the position of the first component 131, and a combination of the position of the right wrist joint and the position of the second component 132 separately.

Then, the operation identification unit 205 performs inference using the combination of the position of the left wrist joint and the position of the first component 131 as input, by using the combination operation identification model that is a trained model trained using combinations of the positions of the left wrist joint and the positions of the object corresponding to the first component 131 as input data, and therefore the operation of handling the first component 131 can be inferred with high confidence.

Further, using the combination operation identification model that is a trained model trained using combinations of the positions of the right wrist joint and the positions of the object corresponding to the second component 132 as input data, the operation identification unit 205 performs inference based on the combination of the position of the right wrist joint and the position of the second component 132 as input, and therefore the operation of handling the second component 132 can also be inferred with high confidence.

The motion analysis device 200 described above can also be implemented by a computer, such as the PC 10 illustrated in FIG. 6, for example.

For example, the object position identification model storage unit 207 can be implemented by the storage 11 or the memory 12.

The object position information acquisition unit 208 can be implemented by the processor 13 executing a program stored in the storage 11.

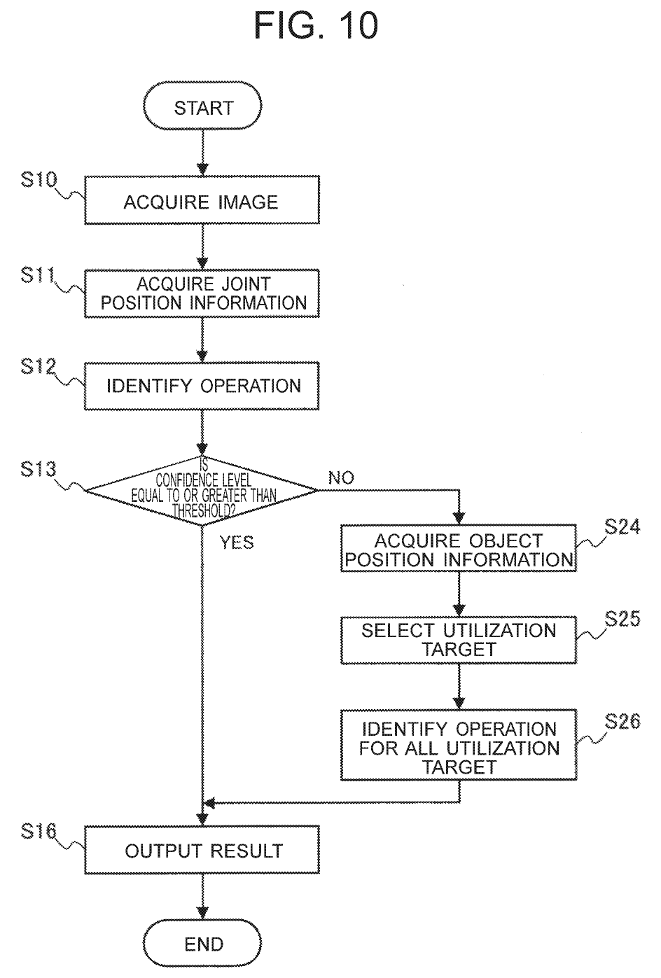

FIG. 10 is a flowchart illustrating the operation of the motion analysis device 200 according to the second embodiment.

In FIG. 10, the steps performing processing similar to those in the flowchart illustrated in FIG. 7 are assigned the same reference numerals as those in the flowchart illustrated in FIG. 7, and detailed explanation thereof will be omitted.

The processing of steps S10 to S13 and the processing of step S16 of the flowchart illustrated in FIG. 10 are similar to the processing of steps S10 to S13 and the processing of step S16 of the flowchart illustrated in FIG. 7.

However, in FIG. 10, if the confidence level is less than a predetermined threshold (NO in S13), the process proceeds to step S24.

Additionally, in FIG. 10, the image acquired in step S10 is provided to the joint position information acquisition unit 103 and the object position information acquisition unit 208.

In step S24, the object position information acquisition unit 208 acquires the object position information indicating the positions of the objects included in the image from the image acquisition unit 101. In the specific example illustrated in FIG. 9, for example, the object position information acquisition unit 208 acquires the object position information indicating the positions of the first component 131 and the second component 132.

Next, in response to a request from the operation identification unit 205, the utilization target selection unit 206 selects a utilization target to be used as input to the trained model, from the joint position information acquired by the joint position information acquisition unit 103 and the object position information acquired by the object position information acquisition unit 208. In the second embodiment, the utilization object selection unit 206 selects a predetermined combination from multiple joints indicated by the joint position information and at least one object indicated by the object position information, and selects the joint and the object of the selected combination and their positions, as a utilization target.

Then, upon receiving the selected utilization target from the utilization target selection unit 206, the operation identification unit 205 inputs the utilization target to the corresponding combination operation identification model stored in the operation identification model storage unit 204, thereby acquiring the operation and the confidence level of the inference, as the inference result (S26). Then, the process proceeds to step S16.

As described above, according to the second embodiment, even if a worker during inference is performing an operation with a motion not exhibited by a worker during training, the operation can be identified with high accuracy by performing inference using part of joints that significantly influences operation inference and an object.

### THIRD EMBODIMENT

FIG. 11 is a block diagram schematically illustrating a configuration of a motion analysis device 300 according to a third embodiment.

The motion analysis device 300 includes an image acquisition unit 101, a joint position identification model storage unit 102, a joint position information acquisition unit 103, an operation identification model storage unit 304, an operation identification unit 305, a utilization target selection unit 306, an object position identification model storage unit 207, an object position information acquisition unit 208, and a distance calculation unit 309.

The image acquisition unit 101, the joint position identification model storage unit 102, and the joint position information acquisition unit 103 of the motion analysis device 300 according to the third embodiment are similar to the image acquisition unit 101, the joint position identification model storage unit 102, and the joint position information acquisition unit 103 of the motion analysis device 100 according to the first embodiment.

However, the image acquisition unit 101 in the third embodiment also provides an acquired image to the object position information acquisition unit 208. The joint position information acquisition unit 103 in the third embodiment provides acquired joint position information to the distance calculation unit 309.

The object position identification model storage unit 207 and the object position information acquisition unit 208 of the motion analysis device 300 according to the third embodiment are similar to the object position identification model storage unit 207 and the object position information acquisition unit 208 of the motion analysis device 200 according to the second embodiment.

However, the object position information acquisition unit 208 in the third embodiment provides acquired object position information to the distance calculation unit 309.

The distance calculation unit 309 calculates the distance between the position of an object and each of the positions of M joints. For example, the distance calculation unit 309 calculates the distances for all combinations of the positions of multiple joints indicated by the joint position information and the position of at least one object indicated by the object position information. The utilization target selection unit 306 is notified of the calculated distances.

The utilization target selection unit 306 selects N joints from the joints whose distances calculated by the distance calculation unit 309 are shorter than a predetermined threshold, to use the positions of the N joints and the position of the object indicated by the object position information as utilization targets. For example, by referring to the distance from the distance calculation unit 309, the utilization target selection unit 306 identifies a joint whose distance from the object is shorter than a predetermined threshold, and selects the object, the identified joint and their positions as the utilization target.

Then, the utilization target selection unit 306 notifies the operation identification unit 305 of the selected utilization targets.

The operation identification model storage unit 304 stores an operation identification model that is a trained model for inferring an operation being performed by a person, based on the positions of the person's joints and the position of object.

The operation identification unit 305 performs inference of the operation being performed by the worker, based on the utilization targets notified from the utilization target selection unit 306, using the trained model stored in the operation identification model storage unit 304, and identifies the operation being performed by the worker from the result of the inference. Here, upon receiving the notification of the selected utilization targets from the utilization target selection unit 306, the operation identification unit 305 inputs the utilization targets into the operation identification model stored in the operation identification model storage unit 304, thereby acquiring the operation and the confidence level of the inference, as the result of the inference. Thus, the operation identification unit 305 identifies the acquired operation as the operation being performed by the worker.

The processing in the distance calculation unit 309, the operation identification unit 305, and the utilization target selection unit 306 will be described below using a specific example.

Here, in this explanation, it is assumed that an operation identification model is trained using combinations of the positions of wrist joints of the worker and the position of the object as input data.

In such a case, during inference using the operation identification model, if the position of the right hand not related to the operation differs from the position during training, the confidence level of the inference using the operation identification model may be lowered, even if the positions of the right wrist joint and the left wrist joint are input into the operation identification model.

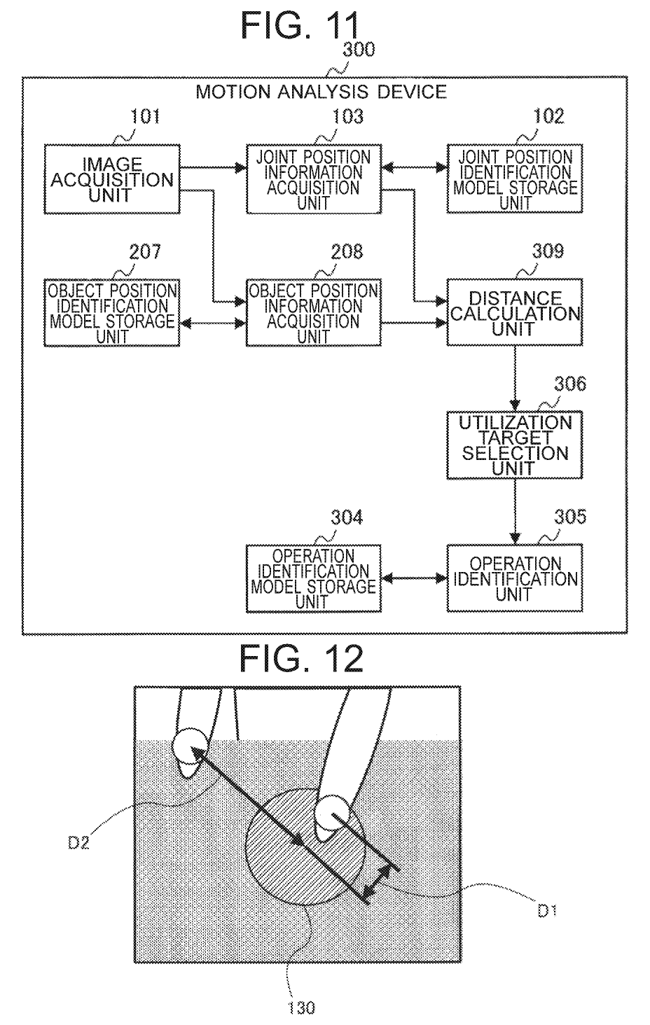

In the third embodiment, as illustrated in FIG. 12, a distance D1 between the product 130 as the object and the position of the joint of the left hand and a distance D2 between the product 130 as the object and the position of the joint of the right hand are calculated by the distance calculation unit 309.

Then, the utilization target selection unit 306 compares the distance D1 and the distance D2 calculated by the distance calculation unit 309 with a predetermined threshold, thereby selecting, as the utilization target, the position of the product 130 and the position of the left wrist joint corresponding to the distance D1 that is shorter than the threshold value.

Then, the operation identification unit 305 performs inference using a combination operation identification model that is a trained model that has been trained using the combination of the position of the left wrist joint and the position of the product 130 as input data, and thus the operation of handling the product 130 can be inferred with high confidence.

The motion analysis device 300 described above can also be implemented by a computer, such as the PC 10 illustrated in FIG. 6.

For example, the distance calculation unit 309 can also be implemented by the processor 13 executing a program stored in the storage 11.

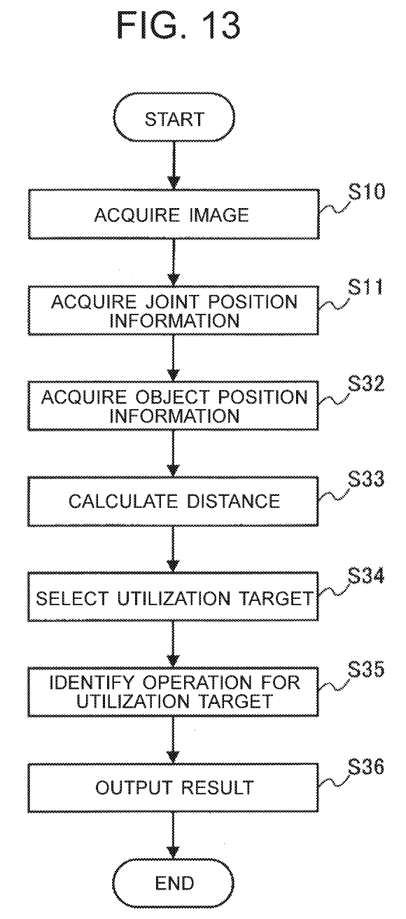

FIG. 13 is a flowchart illustrating the operation of the motion analysis device 300 according to the third embodiment.

In FIG. 13, the steps performing processing similar to those in the flowchart illustrated in FIG. 7 are assigned the same reference numerals as those in the flowchart illustrated in FIG. 7, and detailed description thereof will be omitted.

The processing in steps S10 and S11 of the flowchart illustrated in FIG. 13 is similar to the processing in steps S10 and S11 of the flowchart illustrated in FIG. 7.

However, in FIG. 13, after processing in step S11, the process proceeds to step S32. The joint position information acquired in step S11 is provided to the distance calculation unit 309.

In step S32, the object position information acquisition unit 208 acquires the object position information indicating the position of the object included in the image from the image acquisition unit 101. For example, in the specific example illustrated in FIG. 12, the object position information acquiring unit 208 acquires the object position information indicating the position of the product 130. The acquired object position information is provided to the distance calculation unit 309.

The distance calculation unit 309 calculates the distances for all combinations of the positions of multiple joints indicated by the joint position information and the position of at least one object indicated by the object position information (S33). The calculated distances are notified to the utilization target selection unit 306.

By referring to the distances notified from the distance calculation unit 309, the utilization target selection unit 306 identifies a joint whose distance from the object is shorter than a predetermined threshold, and selects the object, the identified joint, and their positions, as a utilization target (S34).

Then, the utilization target selection unit 306 notifies the operation identification unit 305 of the selected utilization targets.

Upon receiving the notification of the selected utilization targets from the utilization target selection unit 306, the operation identification unit 305 inputs the utilization targets into the operation identification model stored in the operation identification model storage unit 304, thereby acquiring, as the result of the inference, the operation and the confidence level of the inference (S35).

Then, the operation identification unit 305 identifies the operation that is the result of the inference to the utilization targets as being the operation of the worker (S36). Here, multiple operations may be identified.

As described above, according to the third embodiment, even if a worker during inference is performing an operation with a motion not exhibited by a worker during training, the operation can be identified with high accuracy by performing inference using part of joints that significantly influences operation inference and an object.

In step S34 of FIG. 13, the utilization target selection unit 306 selects, as the utilization target, a joint whose distance from the object is shorter than the predetermined threshold, by referring to the distance obtained from the distance calculation unit 309. However, the third embodiment is not limited to this example. For example, the utilization target selection unit 306 may select the joint that is the closest to the object as the utilization target, by referring to the distance obtained from the distance calculation unit 309.

Further, in the third embodiment described above, the utilization target selection unit 306 selects N joints out of the joints whose distances calculated by the distance calculation unit 309 are shorter than a predetermined threshold and sets the positions of the N joints and the position of the object indicated by the object position information as the utilization targets. However, the third embodiment is not limited to this example.

For example, the utilization target selection unit 306 may select N joints out of the joints whose distances calculated by the distance calculation unit 309 are shorter than the predetermined threshold and set the positions of the N joints as the utilization targets.

In the third embodiment, the utilization target is selected based on the distance calculated by the distance calculation section 309, and the operation is identified based on the selected utilization target. However, the third embodiment is not limited to this example.

For example, similarly to Embodiment 1, the operation identification unit 305 may infer an operation based on the positions of the multiple joints, and if the confidence level of the inferred operation is less than a predetermined threshold, the processing of steps S32 to S36 illustrated in FIG. 13 may be executed.

In other words, in the third embodiment, the utilization target selection unit 306 selects N joints, out of the joints whose distances calculated by the distance calculation unit 309 are shorter than the predetermined threshold, when the confidence level of the inference by the operation identification unit 305 is less than the predetermined threshold, and sets the positions of the N joints and the position of the object as the utilization targets. It is assumed that the N joints to be selected here are determined in advance. Then, the operation identification unit 305 performs inference using the utilization targets. In this case as well, the utilization target selection unit 306 does not necessarily need to use the position of the object as the utilization target.

### FOURTH EMBODIMENT

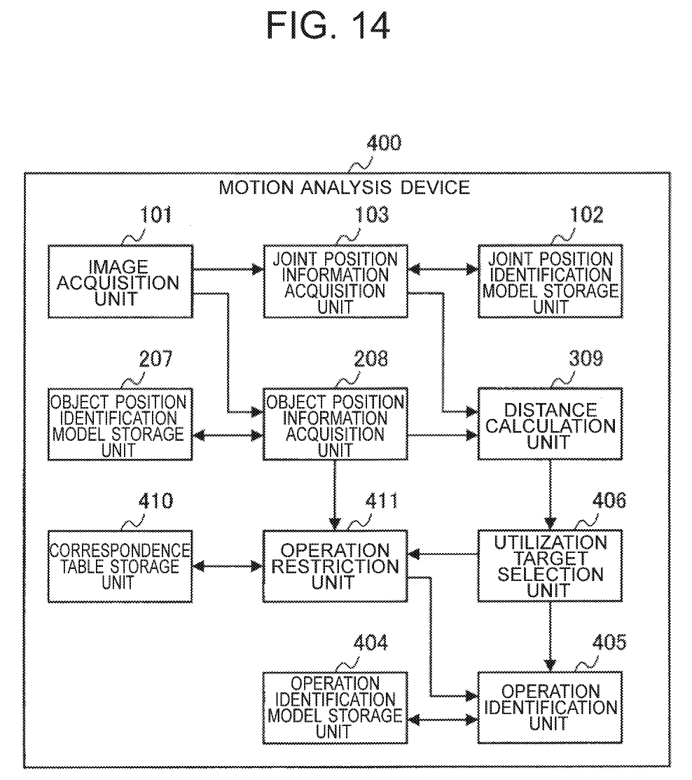

FIG. 14 is a block diagram schematically illustrating a configuration of a motion analysis device 400 according to a fourth embodiment.

The motion analysis device 400 includes an image acquisition unit 101, a joint position identification model storage unit 102, a joint position information acquisition unit 103, an operation identification model storage unit 404, an operation identification unit 405, a utilization target selection unit 406, an object position identification model storage unit 207, an object position information acquisition unit 208, a distance calculation unit 309, a correspondence table storage unit 410, and an operation restriction unit 411.

The image acquisition unit 101, the joint position identification model storage unit 102, and the joint position information acquisition unit 103 of the motion analysis device 400 according to the fourth embodiment are similar to the image acquisition unit 101, the joint position identification model storage unit 102, and the joint position information acquisition unit 103 of the motion analysis device 100 according to the first embodiment.

However, the image acquisition unit 101 in the fourth embodiment also provides the acquired image to the object position information acquisition unit 208. Furthermore, the joint position information acquisition unit 103 in the fourth embodiment provides the acquired joint position information to the distance calculation unit 309.

The object position identification model storage unit 207 and the object position information acquisition unit 208 of the motion analysis device 400 according to the fourth embodiment are similar to the object position identification model storage unit 207 and the object position information acquisition unit 208 of the motion analysis device 200 according to the second embodiment.

However, the object position information acquisition unit 208 in the fourth embodiment provides the acquired object position information to the distance calculation unit 309 and the operation restriction unit 411.

The operation identification model storage unit 304 and the distance calculation unit 309 of the motion analysis device 400 according to the fourth embodiment are similar to the operation identification model storage unit 304 and the distance calculation unit 309 of the motion analysis device 300 according to the third embodiment.

When N joints can be selected out of the joints whose distances calculated by the distance calculation unit 309 are shorter than a predetermined threshold, the utilization target selection unit 406 selects the positions of the N joints selected out of the joints whose distances are shorter than the predetermined threshold and the position of the object indicated by the object position information, as the utilization targets. It is assumed that the N joints to be selected here are determined in advance based on the object located at the distance shorter than the threshold.

On the other hand, when N joints cannot be selected out of the joints whose distances calculated by the distance calculation unit 309 are shorter than the predetermined threshold, the utilization target selection unit 406 selects N joints out of predetermined joints to use the positions of the N joints as the utilization targets.

For example, the utilization target selection unit 406 identifies N joints whose distances from the object are shorter than a predetermined threshold, by referring to the distances obtained from the distance calculation unit 309, and selects the object, the identified joints and their positions as the utilization targets.

Then, the utilization target selection unit 406 notifies the operation identification unit 405 and the operation restriction unit 411 of the selected utilization targets.

Further, when there are no N joints whose distances from the object are shorter than the predetermined threshold, by referring to the distances obtained from the distance calculation unit 309, the utilization target selection unit 406 selects a utilization target to be used as input to the trained model, from the joint position information acquired by the joint position information acquisition unit 103, as in the first embodiment.

Then, the utilization target selection unit 406 notifies the operation identification unit 405 of the selected utilization targets.

The correspondence table storage unit 410 is a correspondence information storage unit that stores a correspondence table, which is correspondence information associating each of multiple operations with at least any one of multiple objects. It is assumed that, in the correspondence table, objects related to operations are associated with each other.

When N joints can be selected out of the joints whose distances calculated by the distance calculation unit 309 are shorter than a predetermined threshold, the operation restriction unit 411 identifies one or more operations associated with the object indicated by the object position information as a candidate operation or candidate operations, by referring to the correspondence information stored in the correspondence table storage unit 410. For example, by referring to the correspondence table stored in the correspondence table storage unit 410, the operation restriction unit 411 identifies an operation associated with the object included in the utilization targets of which the utilization target selection unit 406 notifies the operation restriction unit 411, and notifies the operation identification unit 405 of the identified operation as a candidate operation.

The operation identification model storage unit 404 stores one or more operation identification models for identifying the operation of the worker by using the joint position information of the worker as input. The one or more operation identification models here include a joint operation identification model that is a trained model similar to that in the first embodiment, and a combination operation identification model that is a trained model for inferring the operation of the worker based on a combination of the object position and the joint position.

Upon receiving notification of the selected utilization target from the utilization target selection unit 406, the operation identification unit 405 inputs, depending on the utilization target, the utilization target into the joint operation identification model or the combination operation identification model stored in the operation identification model storage unit 404, and thereby acquiring, as the inference result, the operation and the confidence level of the inference.

Then, in the case where the combination operation identification model is used, when the operation as the inference result matches a candidate operation notified from the operation restriction unit 411, the operation identification unit 405 identifies the operation matching the candidate operation as the operation of the worker.

In other words, when N joints can be selected from the joints whose distances calculated by the distance calculation unit 309 are shorter than the predetermined threshold, the operation identification unit 405 identifies an operation that is inferred based on the utilization target and matches the candidate operation, as the operation of the worker.

On the other hand, when the joint operation identification model is used, the operation identification unit 405 identifies the operation that is the inference result as the operation of the worker.

The motion analysis device 400 described above can also be implemented by a computer such as the PC 10 illustrated in FIG. 6.

For example, the correspondence table storage unit 410 can also be implemented by the storage 11 or the memory 12.

The operation restriction unit 411 can also be implemented by the processor 13 executing a program stored in the storage 11.

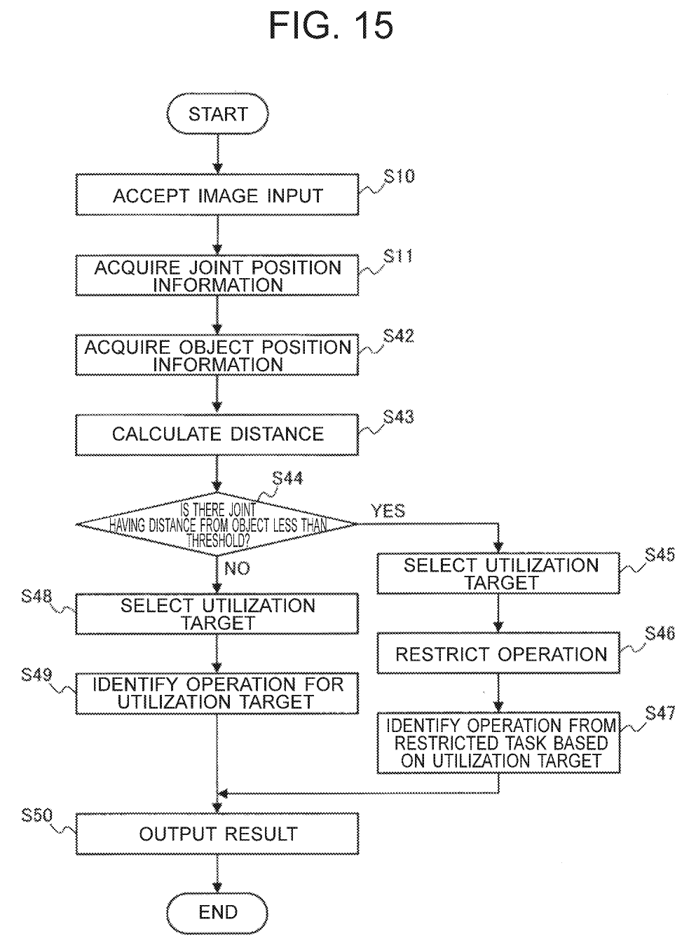

FIG. 15 is a flowchart illustrating the operation of the motion analysis device 400 according to the fourth embodiment.

In FIG. 15, the steps performing processing similar to those in the flowchart illustrated in FIG. 7 are assigned the same reference numerals as those in the flowchart illustrated in FIG. 7, and detailed description thereof will be omitted.

The processing in steps S10 and S11 of the flowchart illustrated in FIG. 15 are similar to the processing in steps S10 and S11 of the flowchart illustrated in FIG. 7.

However, in FIG. 15, after the processing of step S11, the process proceeds to step S42. The joint position information acquired in step S11 is provided to the distance calculation unit 309.

In step S42, the object position information acquisition unit 208 acquires object position information indicating the position of the object included in the image from the image acquisition unit 101. The acquired object position information is provided to the distance calculation unit 309.

The distance calculation unit 309 calculates the distance for each of all combinations of the multiple joint positions indicated by the joint position information and the position of at least one object indicated by the object position information (S43). The calculated distances are notified to the utilization target selection unit 406.

By referring to the distances notified from the distance calculation unit 309, the utilization target selection unit 406 determines whether or not there are predetermined N joints whose distances from the object are shorter than a predetermined threshold (S44). If there are the predetermined N joints whose distances from the object are shorter than the predetermined threshold (YES in S44), the process proceeds to step S45. If there are not the predetermined N joints whose distances from the object are shorter than the predetermined threshold (NO in S44), the process proceeds to step S48.

In step S45, by referring to the distances obtained from the distance calculation unit 309, the utilization target selection unit 406 identifies the predetermined N joints whose distances from the object are shorter than the predetermined threshold, and selects the object, the identified joints and their positions as utilization targets. Then, the utilization target selection unit 406 notifies the operation identification unit 405 and the operation restriction unit 411 of the selected utilization targets.

Upon receiving the notification of the utilization targets from the utilization target selection unit 406, the operation restriction unit 411 identifies an operation associated with the object included in the utilization targets notified from the utilization target selection unit 406, by referring to the correspondence table stored in the correspondence table storage unit 410, and the operation restriction unit 411 then notifies the operation identification unit 405 of the identified operation as a candidate operation (S46).

Upon receiving the notification of the selected utilization targets from the utilization target selection unit 406, the operation identification unit 405 inputs the utilization targets into the combination operation identification model stored in the operation identification model storage unit 404, thereby acquiring, as the inference result, the operation and the confidence level of the inference (S47). Then, the process proceeds to step S50.

On the other hand, if in step S44 there are no predetermined N joints whose distances from the object are shorter than the predetermined threshold (NO in S44), the process proceeds to step S48, and the utilization target selection unit 406 selects a utilization target, which is a target to be used as input to the trained model, from the joint position information acquired by the joint position information acquisition unit 103. Here, as in the first embodiment, the utilization target selection unit 406 selects a predetermined joint, which is part of the multiple joints, out of the multiple joints indicated by the joint position information, and selects the selected joint and its position as a utilization target.

Then, upon receiving the multiple utilization targets selected from the utilization target selection unit 406, the operation identification unit 405 inputs each of the multiple utilization targets into the joint operation identification model stored in the operation identification model storage unit 404, thereby acquiring, as the inference result, the operation and the confidence level of the inference (S46). Then, the process proceeds to step S50.

In step S50, the operation identification unit 405 identifies the operation inferred as above as the operation being performed by the worker. Here, multiple operations may be identified.

As described above, according to the fourth embodiment, even if a worker during inference is performing an operation with a motion not exhibited by a worker during training, the operation can be identified with high accuracy by performing inference using part of joints that significantly influences operation inference and an object.

Further, according to the fourth embodiment, since candidate operations are restricted according to objects used in operations, an operation can be identified with high accuracy.

Here, in the fourth embodiment, when N joints can be selected from the joints whose distances calculated by the distance calculation unit 309 are shorter than the predetermined threshold, the target selection unit 406 uses, as the utilization targets, the positions of the N joints selected from the joints whose distances are shorter than the predetermined threshold and the position of the object indicated by the object position information. However, the fourth embodiment is not limited to this example.

For example, when N joints can be selected from the joints whose distances calculated by the distance calculation unit 309 are shorter than a predetermined threshold, the utilization target selection unit 406 may use, as the utilization targets, the positions of the N joints selected from the joints whose distances are shorter than the predetermined threshold.

Further, in the fourth embodiment, the process of selecting the utilization target is carried out according to the distance calculated by the distance calculation unit 309. However, the fourth embodiment is not limited to this example.

For example, as in the first embodiment, when the operation identification unit 405 infers an operation based on the positions of the multiple joints and the confidence level of the inferred operation is less than a predetermined threshold, steps S42 to S50 illustrated in FIG. 15 may be carried out.

In other words, when N joints can be selected from the joints whose distances calculated by the distance calculation unit 309 are shorter than a predetermined threshold, the utilization target selection unit 406 in the fourth embodiment uses, as utilization targets, the positions of the N joints selected from the joints whose distances are shorter than the predetermined threshold and the position of the object. In this case also, the utilization target selection unit 406 may exclude the position of the object from the utilization target.

On the other hand, when N joints cannot be selected from the joints whose distances are shorter than the predetermined threshold, the utilization target selection unit 406 selects predetermined joints as the N joints and the positions of the N joints as the utilization targets. When N predetermined joints are included in the joints whose distances calculated by the distance calculation unit 309 are shorter than the predetermined threshold, the utilization target selection unit 406 may determine that the N joints can be selected from the joints whose distances calculated by the distance calculation unit 309 are shorter than the predetermined threshold.

Then, when N joints can be selected from the joints whose distances calculated by the distance calculation unit 309 are shorter than the predetermined threshold, by referring to the correspondence information associating each of multiple operations with at least any one of multiple objects, the operation restriction unit 411 identifies one or more operations associated with the object indicated by the object position information as a candidate operation or candidate operations. When the operation inferred based on the utilization target matches such a candidate operation, the operation identification unit 405 identifies the operation that matches the candidate operation as the operation of the worker.

The joint position information acquisition unit 103 in the first to fourth embodiments described above identifies a joint position by using the joint position identification model stored in the joint position identification model storage unit 102. However, the first to fourth embodiments are not limited to the example. The joint position information acquisition unit 103 can identify a joint position by using a conventional technique such as pattern matching, for example, to obtain joint position information indicating the identified joint position.

The object position information acquisition unit 208 in the second to fourth embodiments described above identifies the object position by using the object position identification model stored in the object position identification model storage unit 207. However, the second to fourth embodiments are not limited to the example. The object position information acquisition unit 208 can identify the object position by using a conventional technique, such as pattern matching, for example, to obtain object position information indicating the identified object position.

What is claimed is:

1. A motion analysis device comprising:
a processor to execute a program; and
a memory to store the program which, when executed by the processor, performs processes of,
acquiring joint position information indicating positions of M joints (M being an integer greater than or equal to 2) of a worker included in an image;
performing inference of an operation performed by the worker based on the positions of the M joints by using one of one or more trained models for inferring an operation performed by a person based on at least a joint position of the person, and identifying the operation performed by the worker based on a result of the inference; and
selecting N joints (N being an integer satisfying 1≤N<M) from the M joints when confidence level of the inference is less than a predetermined threshold, and using positions of the N joints as utilization targets;
wherein when the confidence level of the inference is less than a predetermined threshold, the processor is configured to perform again inference of the operation performed by the worker based on the utilization targets by using one of the one or more trained models.

2. The motion analysis device according to claim 1, wherein the processor is configured to select a predetermined joints as the N joints.

3. The motion analysis device according to claim 1,
wherein the processor is configured to acquire object position information indicating a position of an object included in the image; and
wherein the processor is configured to select joints associated with the object in advance as the N joints, and uses the positions of the N joints and the position of the object as the utilization targets.

4. The motion analysis device according to claim 1,
wherein the processor is configured to acquire object position information indicating a position of an object included in the image; and
wherein the processor is configured to calculate a distance between the position of the object and each of the positions of the M joints;
wherein the processor is configured to select joints whose distances are shorter than a predetermined threshold as the N joints.

5. The motion analysis device according to claim 4, wherein the processor is also configured to use the position of the object as the utilization target.

6. The motion analysis device according to claim 1,
wherein the processor is configured to acquire object position information indicating a position of an object included in the image;
wherein the processor is configured to calculate a distance between the position of the object and each of the positions of the M joints; and
wherein when the N joints is able to be selected from joints whose distances are shorter than a predetermined threshold, the processor is configured to use, as the utilization targets, positions of the N joints selected from the joints whose distances are shorter than the predetermined threshold, and when the N joints is not able to be selected from the joints whose distances are shorter than the predetermined threshold, the processor is configured to select predetermined joints as the N joints and use positions of the N joints as the utilization targets.

7. The motion analysis device according to claim 6, wherein when the N joints is able to be selected from joints whose distances are shorter than the predetermined threshold, the processor is also configured to use the position of the object as the utilization targets.

8. The motion analysis device according to claim 6,
wherein the processor is configured to identify, by referring to correspondence information associating each of multiple operations and at least any one of multiple objects, at least one operation associated with the object as a candidate operation,
wherein when the N joints is able to be selected from the joints whose distances are shorter than the predetermined threshold, the processor is configured to identify, as the operation performed by the worker, an operation which is inferred based on the utilization targets and matches the candidate operation.

9. The motion analysis device according to claim 7,
wherein the processor is configured to identify, by referring to correspondence information associating each of multiple operations and at least any one of multiple objects, at least one operation associated with the object as a candidate operation,
wherein when the N joints is able to be selected from the joints whose distances are shorter than the predetermined threshold, the processor is configured to identify, as the operation performed by the worker, an operation which is inferred based on the utilization targets and matches the candidate operation.

10. A motion analysis device comprising:
a processor to execute a program; and
a memory to store the program which, when executed by the processor, performs processes of,
acquiring joint position information indicating positions of M joints (M being an integer greater than or equal to 2) of a worker included in an image;
acquiring object position information indicating a position of an object included in the image;
calculating a distance between the position of the object and each of the positions of the M joints;
selecting N joints (N being an integer satisfying 1≤N<M) from joints whose distances are shorter than a predetermined threshold to use positions of the N joints as utilization targets; and
performing inference of an operation performed by the worker based on the utilization targets by using a trained model for inferring an operation performed by a person based on joint positions of the person and a position of an object, and identifying the operation performed by the worker based on a result of the inference.

11. A motion analysis device comprising:
a processor to execute a program; and
a memory to store the program which, when executed by the processor, performs processes of,
acquiring joint position information indicating positions of M joints (M being an integer greater than or equal to 2) of a worker included in an image;
acquiring object position information indicating a position of an object included in the image;
calculating a distance between the position of the object and each of the positions of the M joints;
using, as utilization targets, positions of N joints (N being an integer satisfying 1≤N<M) selected from joints whose distances are shorter than a predetermined threshold when the N joints is able to be selected from the joints whose distances are shorter than the predetermined threshold, and selecting the N joints from predetermined joints to use positions of the N joints as the utilization targets when the N joints is not able to be selected from the joints whose distances are shorter than the predetermined threshold; and
performing inference of an operation performed by the worker based on the utilization targets by using one of one or more trained models for inferring an operation performed by a person based on at least a joint position of the person, and identifying the operation performed by the worker based on a result of the inference.

12. The motion analysis device according to claim 11,
wherein the processor is configured to identify at least one operation associated with the object as a candidate operation, by referring to correspondence information associating each of multiple operations with at least any one of multiple objects when the N joints is able to be selected from the joints whose distances are shorter than the predetermined threshold,
wherein the processor is configured to identify, as an operation of the worker, an operation which is inferred based on the utilization target and matches the candidate operation when the N joints is able to be selected from the joints whose distances are shorter than the predetermined threshold.

13. A non-transitory computer-readable storage medium storing a program that causes a computer to execute processing comprising:
acquiring joint position information indicating positions of M joints (M being an integer greater than or equal to 2) of a worker included in an image;
preforming inference of an operation performed by the worker based on the positions of the M joints by using one of one or more trained models for inferring an operation performed by a person based on at least a joint position of the person, and identifying the operation performed by the worker based on a result of the inference; and
selecting N joints (N being an integer satisfying 1≤N<M) from the M joints to use positions of the N joints as utilization targets when confidence level of the inference is less than a predetermined threshold;
wherein when the confidence level of the inference is less than the predetermined threshold, the computer is configured to perform again inference of the operation performed by the worker based on the utilization targets by using one of the one or more trained models.

14. A non-transitory computer-readable storage medium storing a program that causes a computer to execute processing comprising:
acquiring joint position information indicating positions of M joints (M being an integer greater than or equal to 2) of a worker included in an image;
acquiring object position information indicating a position of an object included in the image;
calculating a distance between the position of the object and each of the positions of the M joints;
selecting N joints (N being an integer satisfying 1≤N<M) from joints whose distances are shorter than a predetermined threshold to use positions of the N joints as utilization targets; and
performing inference of an operation performed by the worker based on the utilization targets by using a trained model for inferring an operation performed by a person based on a joint position of the person and a position of an object, and identifying the operation performed by the worker based on a result of the inference.

15. A non-transitory computer-readable storage medium storing a program that causes a computer to execute processing comprising:
acquiring joint position information indicating positions of M joints (M being an integer greater than or equal to 2) of a worker included in an image;
acquiring object position information indicating a position of an object included in the image;
calculating a distance between the position of the object and each of the positions of the M joints;
using, as utilization targets, positions of N joints (N being an integer satisfying 1≤N<M) selected from joints whose distances are shorter than a predetermined threshold when the N joints is able to be selected from the joints whose distances are shorter than the predetermined threshold, and selecting the N joints from predetermined joints to use positions of the N joints as the utilization targets when the N joints is not able to be selected from the joints whose distances are shorter than the predetermined threshold; and
performing inference of an operation performed by the worker based on the utilization targets by using one of one or more trained models for inferring an operation performed by a person based on at least a joint position of the person, and identifying the operation performed by the worker based on a result of the inference.

16. A motion analysis method comprising:
acquiring joint position information indicating positions of M joints (M being an integer greater than or equal to 2) of a worker included in an image;
performing inference of an operation performed by the worker based on the positions of the M joints by using a trained model for inferring an operation performed by a person based on at least a joint position of the person, and identifying the operation performed by the worker based on a result of the inference;
selecting N joints (N being an integer satisfying 1≤N<M) from the M joints to use positions of the N joints as utilization targets when confidence level of the inference is less than a predetermined threshold; and
performing inference of the operation performed by the worker again based on the utilization targets by using one of the one or more trained models when the confidence level of the inference is less than the predetermined threshold.

17. A motion analysis method comprising:
acquiring joint position information indicating positions of M joints (M being an integer greater than or equal to 2) of a worker included in an image;
acquiring object position information indicating a position of an object included in the image;
calculating a distance between the position of the object and a position of each of the M joints;
selecting N joints (N being an integer satisfying 1≤N<M) from joints whose distances are shorter than a predetermined threshold to use positions of the N joints as utilization targets; and
performing inference of an operation performed by the worker based on the utilization targets by using a trained model for inferring an operation performed by a person based on a joint position of the person and a position of an object, and identifying the operation performed by the worker based on a result of the inference.

18. A motion analysis method comprising:
acquiring joint position information indicating positions of M joints (M being an integer greater than or equal to 2) of a worker included in an image;
acquiring object position information indicating a position of an object included in the image;
calculating a distance between the position of the object and a position of each of the M joints;
using, as utilization targets, positions of N joints (N being an integer satisfying 1≤N<M) selected from joints whose distances are shorter than a predetermined threshold when the N joints is able to be selected from the joints whose distances are shorter than the predetermined threshold;
selecting the N joints from predetermined joints to use positions of the N joints as the utilization targets when the N joints is not able to be selected from the joints whose distances are shorter than the predetermined threshold; and
performing inference of an operation performed by the worker based on the utilization targets by using one of one or more trained models for inferring an operation performed by a person based on at least a joint position of the person, and identifying the operation performed by the worker based on a result of the inference.
